(19) United States
(12) Patent Application Publication
(10) Pub. No.: US 2004/0100498 A1
(43) Pub. Date: May 27, 2004

(54) Annotating received world wide web/internet document pages without changing the hypertext markup language content of the pages

(75) Inventors: Timothy Alan Dietz, Austin, TX (US); Walid Kobrosly, Round Rock, TX (US); Nadeem Malik, Austin, TX (US)

Correspondence Address: Mark E. McBurney, International Business Machines Corporation, Intellectual Property Law Department, Internal Zip 4054, 11400 Burnet Road, Austin, TX, 78758, US

(73) Assignee: International Business Machines Corporation, Armonk, NY

(21) Appl. No.: 10/302,467

(22) Filed: Nov. 21, 2002

(51) Int. Cl. G09G 5/00

(52) U.S. Cl. 345/760; 345/768

(57) ABSTRACT

A Web page function that enables the interactive user to simply annotate a received Web document/page with text and graphics entries that may be stored separately from the stored Web page so that the annotations track the stored Web page, and may be subsequently accessed and displayed whenever the Web page is accessed and displayed. As a result, it is not necessary for the user to do any editing in the HTML format of the Web page that remains unchanged. Apparatus at a receiving display station for displaying the received hypertext document, and an implementation for superimposing a transparent displayed layer over the displayed received hypertext document, and user interactive apparatus enabling the entry of displayed data into said superimposed layer relative to said underlying displayed hypertext document. The received document is customarily a hypertext markup language document, and the displayed data entered into said superimposed layer is not defined in hypertext markup language. Therefore, apparatus provided at the receiving display station for storing the received hypertext markup language document, and apparatus is also provided at the receiving display station for storing said displayed entered data separate and independent of said received document.

### TECHNICAL FIELD

The present invention relates to computer managed communication networks such as the World Wide Web (Web) and, particularly, to systems, processes and programs for making the interactive user display interface, i.e. GUI, to Web pages received from the Web more user friendly and easier to use.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet or Web related distribution of documents, media and programs. The convergence of the electronic entertainment and consumer industries with data processing exponentially accelerated the demand for wide ranging communication distribution channels, and the Web or Internet, which had quietly existed for over a generation as a loose academic and government data distribution facility, reached “critical mass” and commenced a period of phenomenal expansion. With this expansion, businesses and consumers have direct access to all matter of documents, media and computer programs.

In addition, Hypertext Markup Language (HTML), which had been the documentation language of the Internet or Web for years, offered direct hyperlinks between Web pages embedded in such Web pages. This even further exploded the use of the Internet or Web.

As a result of these changes, it seems as if virtually all aspects of human endeavor in the industrialized world require human-computer interfaces. These changes have made computer directed activities accessible to a substantial portion of the industrial world's population which, up to a few years ago, was computer-illiterate, or, at best, computer indifferent.

Consequently, developers of Web documents/pages are continually working to make the handling of Web pages as simple and user-friendly as possible. Such simplification, of course, involves the interactive user interfaces to Web pages. At the present time, it is fairly easy and straight-forward for a user to print a Web page under the control of any standard Web browser program. Likewise, current Web browser programs enable the user to request to have the Web page downloaded and saved in its HTML format so that users may subsequently request that the browser fetch and display the Web page in its hypertext format whereby the user may still use the page hyperlinks to access linked documents.

However, there has been a lack of programming technology permitting the interactive user to simply make notes, sketches, highlight or otherwise annotate received Web pages for subsequent access and use by the user. While there are programs for the editing of HTML documents available in the art, these are relatively complex for most Web/Internet users/consumers because such programs require the acquisition of HTML operator skills.

### SUMMARY OF THE PRESENT INVENTION

The present invention is directed to a unique Web page function that enables the interactive user to simply annotate a received Web document/page with text and graphics entries that may be stored separately from the stored Web page so that the annotations track the stored Web page and, subsequently, may be accessed and displayed whenever the Web page is accessed and displayed. As a result, it is not necessary for the user to do any editing in the HTML format of the Web page that remains unchanged.

Accordingly, the present invention provides for the annotation of a displayed received Web document without changing the received document content comprising the combination of means at a receiving display station for displaying the received hypertext document, means for superimposing a transparent displayed layer over said displayed received hypertext document, and user interactive means enabling the entry of displayed data into said superimposed layer relative to said underlying displayed hypertext document. The received document is customarily a hypertext markup language document, and the displayed data entered into said superimposed layer is not defined in hypertext markup language. Therefore, means are provided at the receiving display station for storing the received hypertext markup language document, and means are also provided at the receiving display station for storing said displayed entered data separate and independent of said received document.

The system is more specifically implemented by Web browsing means at the receiving display station including the above means for superimposing a transparent displayed layer over the displayed received hypertext document and the user interactive means enabling the entry of displayed data into the superimposed layer relative to the underlying displayed hypertext document.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a generalized data processing system including a central processing unit that provides the computer controlled interactive display system that may be used in practicing the present invention;

FIG. 2 is a generalized diagrammatic view of a Web portion upon which the present invention may be implemented;

FIG. 3 is a diagrammatic view of a typical Web page displayed at a receiving display station;

FIG. 4 is the diagrammatic Web page view of FIG. 3, after a user has annotated the Web page with text and graphics in accordance with the present invention;

FIG. 5 is an illustration showing how the Web page view of FIG. 4 may be separated into its two discrete layers;

FIG. 6 is an illustrative flowchart describing the setting up of the process of the present invention for providing of a separate annotation layer for the underlying HTML Web page; and

FIG. 7 is a flowchart of an illustrative run of the process setup in FIG. 6.

### DETAILED DESCRIPTION OF THE PREFERRED EMBODIMENT

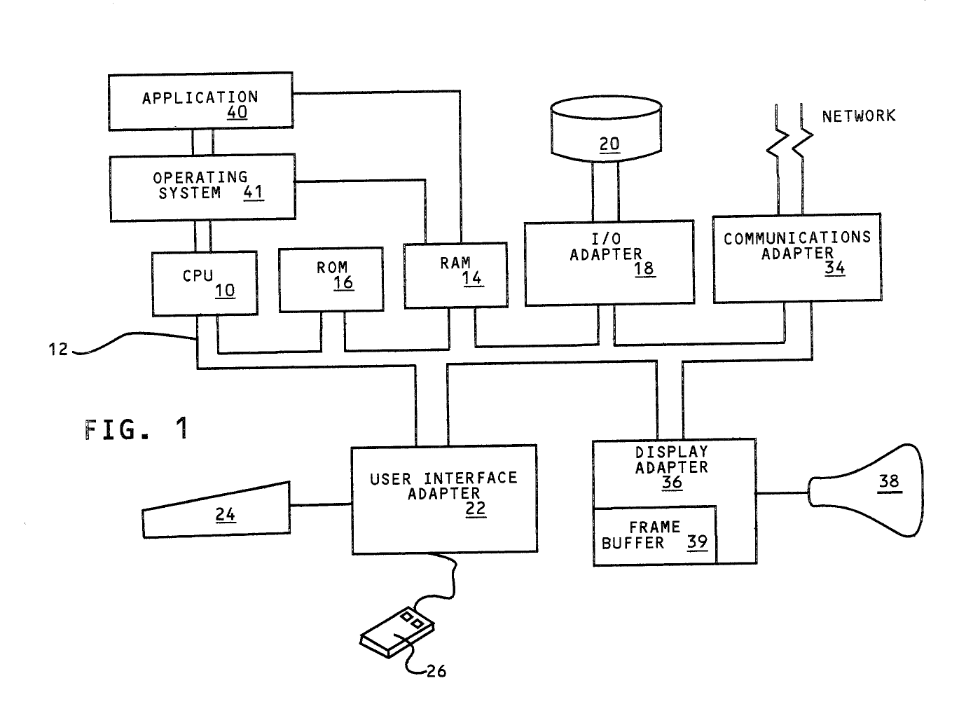

Referring to FIG. 1, a typical data processing terminal is shown that may function as the Web display stations used for receiving Web pages, for requesting Web searches and for Web browsing. A central processing unit (CPU) 10, such as one of the PC microprocessors or workstations, e.g. RISC System/6000™ series available from International Business Machines Corporation (IBM) or Dell PC microprocessors, is provided and interconnected to various other components by system bus 12. An operating system 41 runs on CPU 10, provides control and is used to coordinate the function of the various components of FIG. 1. Operating system 41 may be one of the commercially available operating systems such as the AIX 6000™ operating system available from IBM; or Microsoft's WindowsXP™ or Windows2000™, or WindowsNT™, as well as other UNIX and AIX operating-systems. Application programs 40, controlled by the system, are moved into and out of the main memory Random Access Memory (RAM) 14. These programs include the programs of the present invention for annotating received Web documents without changing the Web document content. The programs will be subsequently described in combination with any conventional Web browser, such as the Netscape Navigator 3.0 or Microsoft's Internet Explorer™. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside network enabling the data processing system to communicate with other-such-systems over the Web or Internet The latter two terms are meant to be generally interchangeable and are so used in the present description of the distribution network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to Web pages. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective the various elements and methods that may be related to the present invention. Since a major aspect of the present invention is directed to documents, such as Web pages transmitted over networks, an understanding of networks and their operating principles would be helpful. We will not go into great detail in describing the networks to which the present invention is applicable. Reference has also been made to the applicability of the present invention to a global network such as the Internet or Web. For details on Internet nodes, objects and links, reference is made to the text, Mastering the Internet, G. H. Cady et al., published by Sybex Inc., Alameda, Calif., 1996.

The Internet or Web is a global network of a heterogeneous mix of computer technologies and operating systems. Higher level objects are linked to the lower level objects in the hierarchy through a variety of network server computers. These network servers are the key to network distribution, such as the distribution of Web pages and related documentation. In this connection, the term “documents” is used to describe data transmitted over the Web or other networks and is intended to include Web pages with displayable text, graphics and other images.

Web documents are conventionally implemented in HTML language, which is described in detail in the text entitled Just Java, van der Linden, 1997, SunSoft Press, particularly at Chapter 7, pp. 249-268, dealing with the handling of Web pages; and also in the above-referenced Mastering the Internet, particularly at pp. 637-642, on HTML in the formation of Web pages. The images on the Web pages are implemented in a variety of image or graphic files such MPEG, JPEG or GIF files, which are described in the text, Internet: The Complete Reference, Millennium Edition, Young et al., 1999, Osborne/McGraw-Hill, particularly at pp. 728-730.

In addition, aspects of this invention will involve Web browsers. A general and comprehensive description of browsers may be found in the above-mentioned Mastering the Internet text at pp. 291-313. More detailed browser descriptions may be found in the above-mentioned Internet: The Complete Reference, Millennium Edition text: Chapter 19, pp. 419-454, on the Netscape Navigator; Chapter 20, pp. 455-494, on the Microsoft Internet Explorer; and Chapter 21, pp. 495-512, covering Lynx, Opera and other browsers. The invention may involve the use of search engines for searching. As described in the above-mentioned Internet: The Complete Reference, Millennium Edition text, pages 395 and 522-535, search engines use key words and phrases to query the Web for desired subject matter.

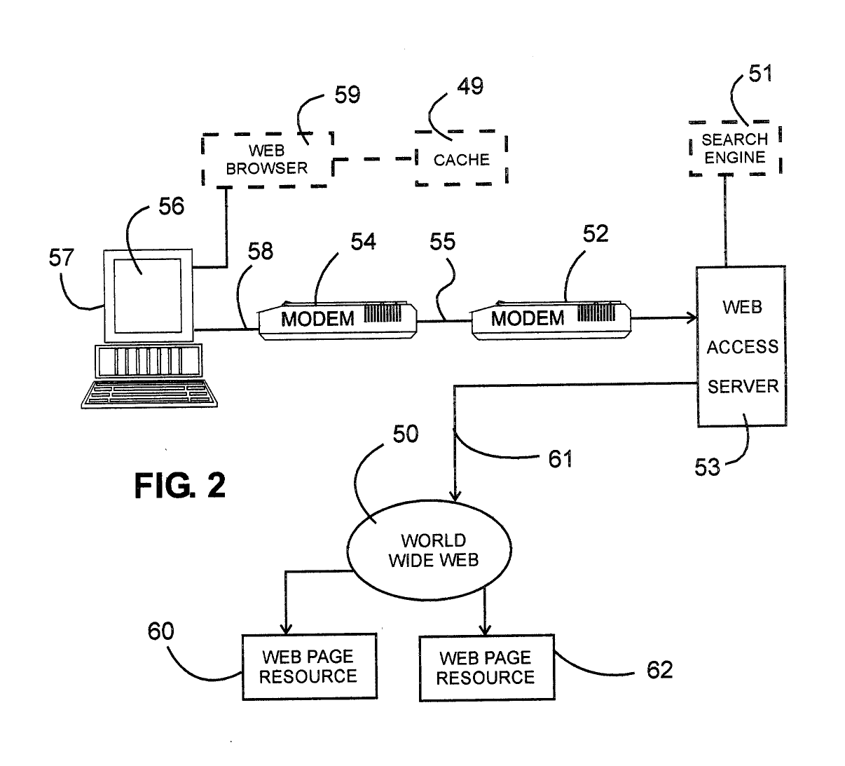

A generalized diagram of a portion of the Web, which the computer controlled display terminal 57 used for Web page receiving during searching or browsing, is connected as shown in FIG. 2. Computer display terminal 57 may be implemented by the computer system setup in FIG. 1 and connection 58 (FIG. 2) is the network connection shown in FIG. 1. For purposes of the present embodiment, computer 57 serves as a Web display station and has received displayed Web page 56, which is one of a sequence of Web pages containing text, graphics and embedded hyperlinks to other Web pages. Reference may be made to the above-mentioned Mastering the Internet, pp. 136-147, for typical connections between local display stations to the Web via network servers, any of which may be used to implement the system on which this invention is used. The system embodiment of FIG. 2 has a host-dial connection. Such host-dial connections have been in use for over 30 years through network access servers 53 which are linked 61 to the Web 50. The Web servers 53, which also may have the computer structure described with respect to FIG. 1, may be maintained by an ISP (Internet Service Provider) to the client's display terminal 57. The Web server 53 is accessed by the client terminal 57 through a normal dial-up telephone linkage 58 via modem 54, telephone line 55 and modem 52. The HTML file representative of the Web page 56 has been downloaded to display terminal 57 through Web access server 53 via the telephone line linkages from server 53, which may have accessed them from the Internet 50 via linkage 61. The Web browser program 59 operates within the display terminals 57 to control the communication with the Web access server 53 to thereby download and display the accessed Web pages 56 on terminal 57. The Web access server 53 uses one of the previously mentioned search engines 51 to access via the Web 50 the desired sequence of Web pages from appropriate Web resources, such as databases 60 and 62. Web server 53 will carry out the functions of obtaining the Web documents or pages as requested by the user via Web browser 59 and downloaded into storage in Web cache 49.

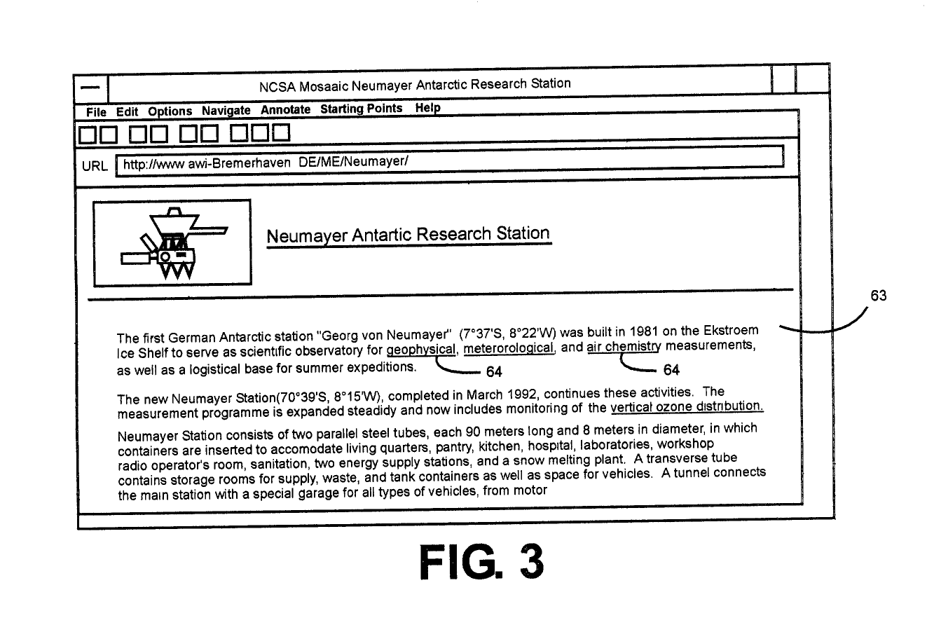

With this setup, the present invention, which will be described in greater detail with respect to FIGS. 3 through 5, may be carried out using Web browser 59 and associated Web server 53 (FIG. 2). Search engine 51 accesses the sequence of Web pages and provides such pages to the user at terminal 57 via Web browser 59 via server 53.

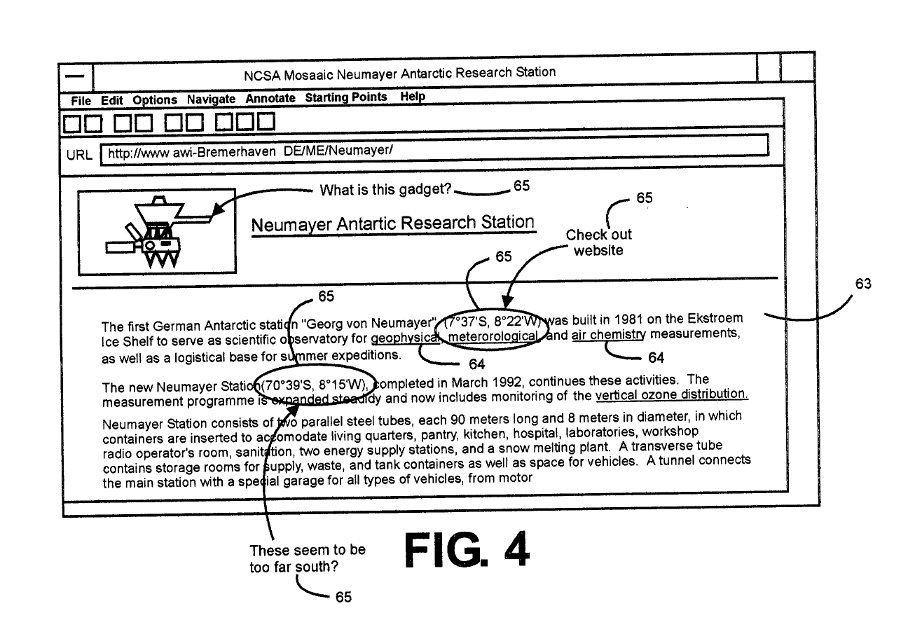

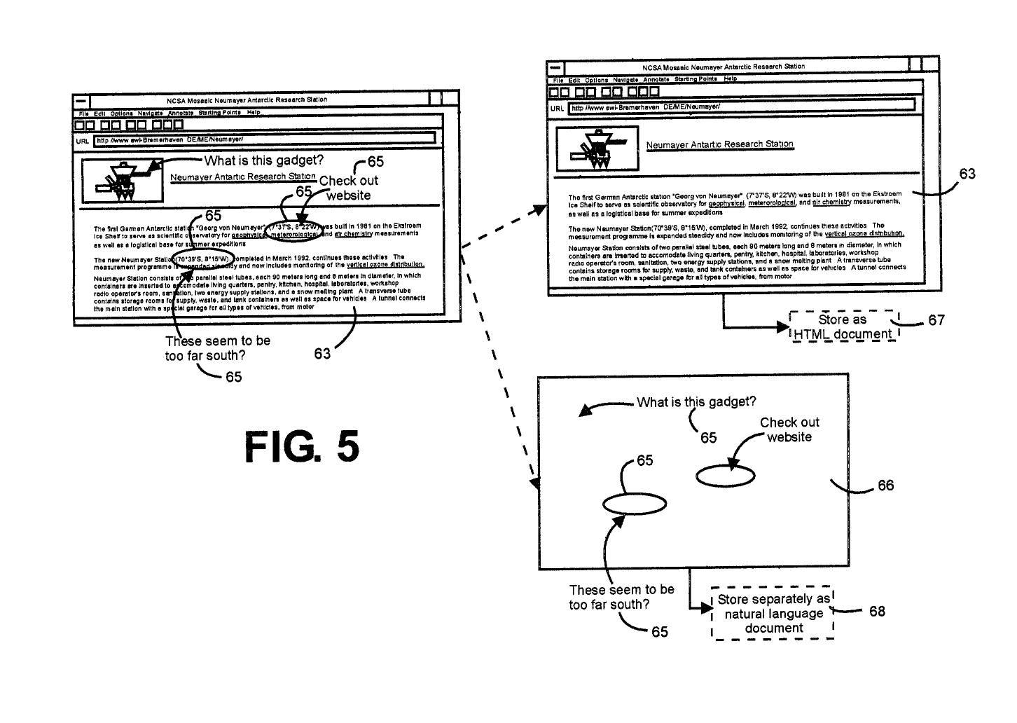

Now, with respect to FIGS. 3 through 5, we will give an illustrative example of how the present invention may be used to provide an implementation for annotating a received Web page without changing the HTML content of the page. Web page 63, FIG. 3, is an illustration of the displayed Web page 56 in FIG. 2. This standard page contains text, graphics and images, as well as hyperlinks 64 to other Web documents. Using the basic text/graphics editing function of the operating system, e.g. Windows 2000, or any conventional word processing program operable on the Windows OS, e.g. Word, WordPro or Word Perfect, the user may annotate the Web page content 63 with text/graphics entries 65 as shown in FIG. 4. These entries will not in any way change or edit the displayed or stored content of Web page 63. The annotations will in effect be made in a “transparent” layer over the Web page 63 by the text/graphics processor used in the same manner as if there were no Web page present and the display was blank. The only relationship that the text/graphics annotations 65 have to the underlying Web page 63 is the spatial one shown in FIG. 4. This is illustrated in FIG. 5. The initial composite overlay of FIG. 4 is shown separated into the basic Web page of FIG. 3 and transparent overlay 66 containing annotations 65. Basic Web page 63 is stored 67 as an unchanged HTML page, while transparent overlay 66 with annotations is stored separately 68 as a natural language word processing document. The Web page and overlay may initially being stored in cache 49 (FIG. 2) under control of the Web browser or subsequently in disk storage 20 (FIG. 1).

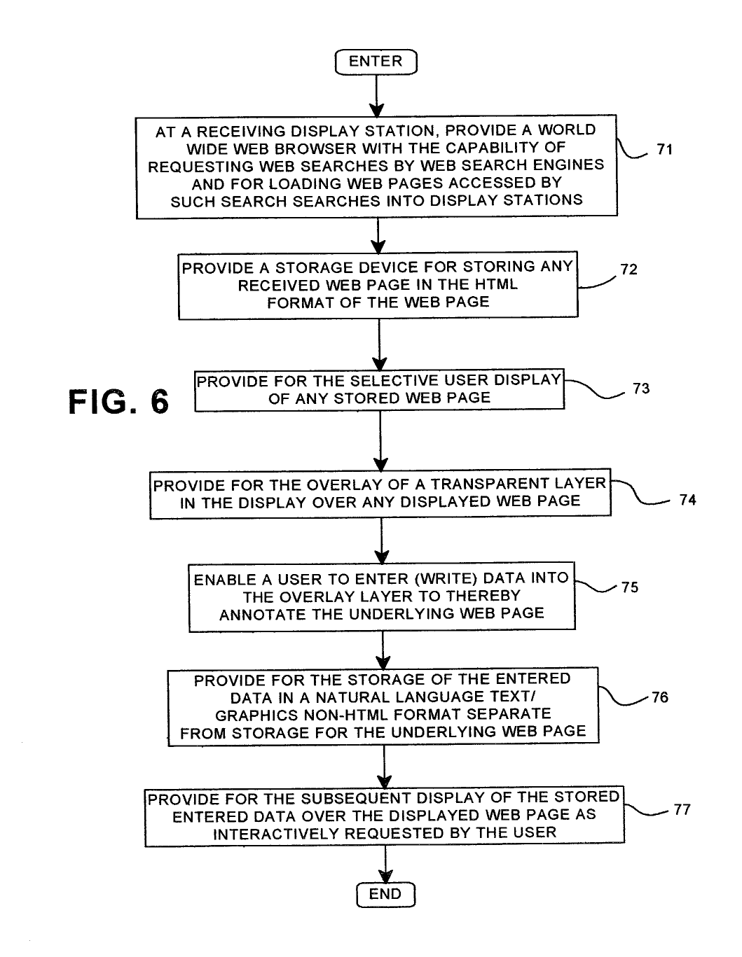

FIG. 6 is a flowchart showing the development of a process according to the present invention for annotating received Web pages without affecting the HTML content of the Web page. Most of the programming functions in the process of FIG. 6 have already been described in general with respect to FIGS. 3 through 5. A Web browser is provided at a receiving display station on the Web for accessing Web pages in the conventional manner and loading them at the display station, step 71. The Web pages are conventionally obtained via a Web server provided by an ISP. The Web browser has the capability of requesting searches from one or more search engines available through the Web. A conventional storage apparatus is provided for storing a received Web page in its HTML format, step 72. Provision is made for the user selecting to display a Web page as controlled by the Web browser, step 73. A transparent overlay on the display is provided for as previously described, step 74. A user is enabled to enter or write data into the overlay layer to thereby annotate the underlying Web page with text/graphics, step 75. This may be done with standard text/graphics editing programs as described hereinabove with respect to FIG. 4. Storage is provided for the data entered into the overlay in a natural language format as distinguished from an HTML format in which the Web page is stored. This storage is separate and independent of the above-mentioned storage for the Web page, step 76. As requested by the interactive user, provision is made for the subsequent display of the stored overlay entered data over the displayed Web page, step 77.

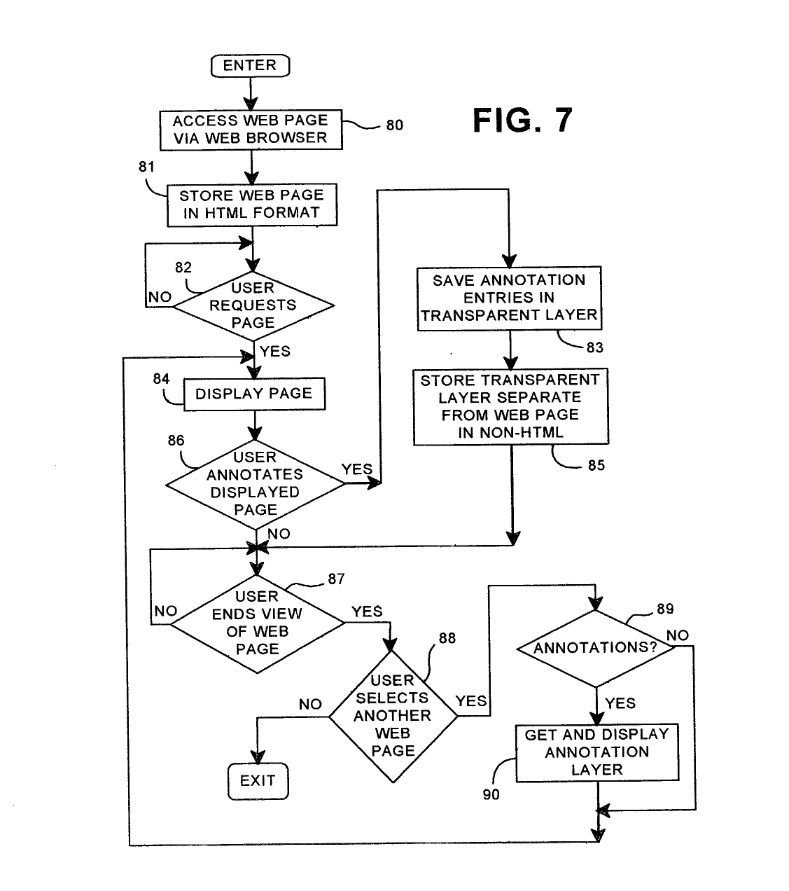

The running of the process set up in FIG. 6 and described in connection with FIGS. 3 through 5 will now be described with respect to the flowchart of FIG. 7. Let us assume that we are in a Web browsing session through the browser. The flowchart represents some steps in a routine that will illustrate the operation of the invention. The browser, via a Web access server, accesses the pages found by a search engine; the next Web page is accessed, step 80. This accessed Web page is stored in its HTML format, step 81. A determination is then made as to whether the user has requested the page, step 82. If No, such a request is awaited. If Yes, the page is displayed, step 84. During the display of this Web page, a determination is made as to whether the user has annotated the Web page as described above, step 86. If Yes, the annotation entries into the transparent layer are saved, step 83 and the transparent layer is stored in natural language non-HTML format separate from the stored Web page, step 85. Next, or if the decision from step 86 is No, a determination is made as to whether the user has completed his viewing of the Web page, step 87. If No, the user in permitted to continue viewing the page. If Yes, a further determination is made as to whether the user has selected another Web page for viewing, step 88. If No, the session is exited. If Yes, a further determination is made as to whether the selected Web page has already been annotated, step 89. If Yes, the annotation layer associated with the Web page is obtained to be displayed, step 90. Then, or if there was no annotation as yet, the process is branched back to step 84 where the Web page with or without a associated annotation overlay is displayed and the process is continued as described hereinabove.

One of the preferred implementations of the present invention is in application program 40, i.e. a browser program made up of programming steps or instructions resident in RAM 14, FIG. 1, of a Web receiving station and/or Web server during various Web operations. Until required by the computer system, the program instructions may be stored in another readable medium, e.g. in disk drive 20, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Web itself, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In a World Wide Web (Web) communication network with user access via a plurality of data processor controlled interactive receiving display stations for displaying received hypertext documents of at least one display page containing text, images and a plurality of embedded hyperlinks to other hypertext documents accessible from sources on the Web, a system for annotating a displayed received document without changing said received document content comprising:
means at a receiving display station for displaying the received hypertext document;
means for superimposing a transparent displayed layer over said displayed received hypertext document; and
user interactive means enabling the entry of displayed data into said superimposed layer relative to said underlying displayed hypertext document.

2. The network system of claim 1 wherein:
said received document is a hypertext markup language document; and
said displayed data entered into said superimposed layer is not defined in hypertext markup language.

3. The network system of claim 2 further including:
means at said receiving display station for storing said received hypertext markup language document; and
means at said receiving display station for storing said displayed entered data separate and independent of said received document.

4. The network system of claim 1 further comprising; Web browsing means at said receiving display station including:
said means for superimposing a transparent displayed layer over said displayed received hypertext document; and
said user interactive means enabling the entry of displayed data into said superimposed layer relative to said underlying displayed hypertext document.

5. The network system of claim 4 further including:
means associated with said browsing means at said receiving display station for storing said received hypertext markup language document; and
means associated with said browsing means at said receiving display station for storing said displayed entered data separate and independent of said received document.

6. The network system of claim 5 further including a cache associated with said browser including said means storing said received hypertext document and said means for storing said displayed entered data.

7. The network system of claim 6 wherein said displayed entered data includes text.

8. The network system of claim 6 wherein said displayed entered data includes highlighting.

9. In a Web communication network with user access via a plurality of data processor controlled interactive receiving display stations for displaying received hypertext documents of at least one display page containing text, images and a plurality of embedded hyperlinks to other hypertext documents accessible from sources on the Web, a method for annotating a displayed received document without changing said received document content comprising;
displaying the received hypertext document at a receiving display station;
superimposing a transparent displayed layer over said displayed received hypertext document; and
enabling the user interactive entry of displayed data into said superimposed layer relative to said underlying displayed hypertext document.

10. The method of claim 9 further:
said received document is a hypertext markup language document; and
said displayed data entered into said superimposed layer is not defined in hypertext markup language.

11. The method of claim 10 further including the steps of:
storing said received hypertext markup language document at said receiving display station; and
storing said displayed entered data at said receiving display station separate and independent of said received document.

12. The method of claim 9 further comprising:
a Web browsing process at said receiving display station including:
said step of superimposing a transparent displayed layer over said displayed received hypertext document; and
said step of enabling the user interactive entry of displayed data into said superimposed layer relative to said underlying displayed hypertext document.

13. The method of claim 12 further including the steps of:
storing said received hypertext markup language document in association with said browsing process at said receiving display station for; and
storing said displayed entered data separate and independent of said received document in association with said browsing process at said receiving display station.

14. The method of claim 13 further including the step of storing said received hypertext document and said displayed entered data in a cache.

15. The method of claim 14 wherein said displayed entered data includes text.

16. The method of claim 14 wherein said displayed entered data includes highlighting.

17. A computer program having code recorded on a computer readable medium for annotating a displayed document received at a Web display station without changing said document comprising:
means for displaying the received hypertext document at said receiving display station;
means for superimposing a transparent displayed layer over said displayed received hypertext document; and
user interactive means enabling the entry of displayed data into said superimposed layer relative to said underlying displayed hypertext document.

18. The computer program of claim 17 wherein:
said received document is a hypertext markup language document; and
said displayed data entered into said superimposed layer is not defined in hypertext markup language.

19. The computer program of claim 18 further including:
means for storing said received hypertext markup language document at said receiving display station; and
means for storing at said receiving display station said displayed entered data separate and independent of said received document.

20. The computer program of claim 17 further comprising; a Web browser program at said receiving display station including:
means for superimposing a transparent displayed layer over said displayed received hypertext document; and
user interactive means enabling the entry of displayed data into said superimposed layer relative to said underlying displayed hypertext document.

21. The computer program of claim 20 further including:
means associated with said browsing means at said receiving display station for storing said received hypertext markup language document; and
means associated with said browsing means at said receiving display station for storing said displayed entered data separate and independent of said received document.

22. The computer program of claim 21 further including a cache associated with said browser including said means for storing said received hypertext document and said means for storing said displayed entered data.

23. The computer program of claim 22 wherein said displayed entered data includes text.

24. The computer program of claim 22 wherein said displayed entered data includes highlighting.

25. In a Web communication network with user access via a plurality of data processor controlled interactive receiving display stations for displaying received hypertext documents of at least one display page containing text, images and a plurality of embedded hyperlinks to other hypertext documents accessible from sources on the Web, a system for annotating a displayed received document without changing said received document content comprising:
a receiving display station for displaying the received hypertext document;
an implementation for superimposing a transparent displayed layer over said displayed received hypertext document; and
user interactive apparatus enabling the entry of displayed data into said superimposed layer relative to said underlying displayed hypertext document.

26. The network system of claim 25 wherein:
said received document is a hypertext markup language document; and
said displayed data entered into said superimposed layer is not defined in hypertext markup language.

27. The network system of claim 26 further including:
storage apparatus at said receiving display station for storing said received hypertext markup language document; and
storage apparatus at said receiving display station for storing said displayed entered data separate and independent of said received document.

28. The network system of claim 25 further comprising; a Web browser at said receiving display station including:
said implementation for superimposing a transparent displayed layer over said displayed received hypertext document; and
said user interactive apparatus enabling the entry of displayed data into said superimposed layer relative to said underlying displayed hypertext document.

29. The network system of claim 28 further including:
storage apparatus at said receiving display station for storing said received hypertext markup language document; and
storage apparatus at said receiving display station for storing said displayed entered data separate and independent of said received document.

30. The network system of claim 29 further including a cache associated with said browser including said storage apparatus for said received hypertext document and said storage apparatus for said displayed entered data.
